(19) United States
(12) Patent Application Publication
(10) Pub. No.: US 2006/0158871 A1
(43) Pub. Date: Jul. 20, 2006

(54) Enhanced nail clippers and system thereof

(76) Inventors: Timothy Paul Hopkins, Round Rock, TX (US); Daniel Russ Dykstra, Atlanta, GA (US); Gregory James Sirmans, Atlanta, GA (US)

Correspondence Address: CTS SOLUTIONS, LLC, 401 N. CROMWELL RD, UNIT Q3, SAVANNAH, GA, 31410, US

(21) Appl. No.: 11/169,414

(22) Filed: Jun. 29, 2005

Related U.S. Application Data
(60) Provisional application No. 60/644,674, filed on Jan. 18, 2005.

(51) Int. Cl. B25B 23/18

(52) U.S. Cl. 362/119

(57) ABSTRACT

Systems, methods, and devices for better manicuring a patient's nails are disclosed. A representative embodiment is a system that includes a lighting element for transilluminating the nail, a power supply for powering the lighting element, and a switch for activating the lighting element.

### CROSS-REFERENCE TO RELATED APPLICATION

This application claims priority to copending U.S. provisional application entitled, “Enhanced Nail Clippers,” having Ser. No. 60/644,674 filed Jan. 18, 2005, which is entirely incorporated herein by reference.

### FIELD OF THE INVENTION

The present invention generally relates to nail clippers. More specifically, the invention relates to nail clippers for animals, such as dogs and cats.

### DESCRIPTION OF THE RELATED ART

Some animals, such as dogs, have veins present in the center and toward the base of their nails. If an owner or groomer accidentally cuts the quick of the nail (the vein), not only does it cause the animal pain, but the wound bleeds profusely. For animals with light colored nails, the quick can often be seen with the naked eye. For animals with dark colored nails it is very difficult to see where the quick ends. It is important to cut an animal's nail as close to the quick as possible because the quick will grow over time if the nails are not cut back filly. To shorten the quick the animal must be anesthetized and all the nails cut to the base and through the quick.

Nail clippers are available today that use an adjustable stop that limit the amount of nail that is cut off. This prevents the user from cutting the quick only if they know exactly how much to cut off. If the guard is set to a length that is safe on one nail it may not be safe on another nail. Animals' nails grow and wear differently even on the same foot/paw.

Another type of clipper that attempts to deal with this issue clips the nail based on diameter. That method assumes that the quick ends where the nail is at a specific diameter. Although this may help keep the user from cutting the nails too short, it does not identify the location of the quick and, thus, the possibility of either cutting the quick or leaving the nails too long remains.

U.S. Pat. No. 6,220,251 to Jeong et al. (hereinafter “Jeong”), entitled Combination Vision Enhancement Kit and Nail Clipper, illustrates a conventional nail clipper with accompanying lens to magnify the respective cutting area. Furthermore, the Jeong patent teaches a light source that could further be used to enhance the field of view (See Col. 2, lines 45-53) by illuminating the general viewing area. The Jeong patent is generally focused on nail clippers to be used for human nails, and so fails to recognize the need to clip animal nails as close to the quick as possible.

As such, there remains an unsatisfied need in the market for nail clippers that better provide for clipping animals' nails, given the unique features of such nails as just previously mentioned.

### SUMMARY OF THE INVENTION

Various embodiments of the present invention are illustrated in the present disclosure. A first embodiment of the present invention is a system for enhancing the clipping of a nail. The system comprises a lighting element for transilluminating the nail, a power supply for powering the lighting element, and a switch for activating the lighting element.

A second embodiment is a nail clipper that includes a lighting element coupled to a first reciprocating blade. The lighting element is positioned to transilluminate a patient's nail.

A third embodiment is a system for enhancing the clipping of a patient's nail. The system comprises means for transilluminating the patient's nail such that the quick of the nail becomes better visible.

A fourth embodiment is a method for better manicuring an animal's nail. The method includes: aligning a lighting element to a target nail such that the target nail is transilluminated to visually expose the location of the animal's quick; positioning a cutting instrument to a desirable location, relative to the quick, of the target nail; and cutting the target nail with the cutting instrument.

### BRIEF DESCRIPTION OF THE DRAWINGS

Many aspects of the invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 is an illustration of a conventional pet nail clipper.

FIG. 2A is an illustration of a pet's nail when not illuminated by a device embodying the present invention.

FIG. 2B is an illustration of a pet's nail when transilluminated by a device embodying the present invention.

FIG. 3 is a perspective view illustrating an embodiment of an enhanced nail clipper system in accordance with the present invention.

FIG. 4A is a perspective view illustrating a first embodiment of an enhanced nail clipper in accordance with the present invention.

FIG. 4B is a perspective view illustrating a second embodiment of an enhanced nail clipper in accordance with the present invention.

FIG. 5 is a perspective view illustrating a third embodiment of the enhanced nail clipper in accordance with the present invention.

FIG. 6 is a perspective view illustrating a fourth embodiment of the enhanced nail clipper in accordance with the present invention.

FIG. 7 is a block diagram illustrating a novel method for grooming an animal's nails in accordance with the present invention.

### DETAILED DESCRIPTION

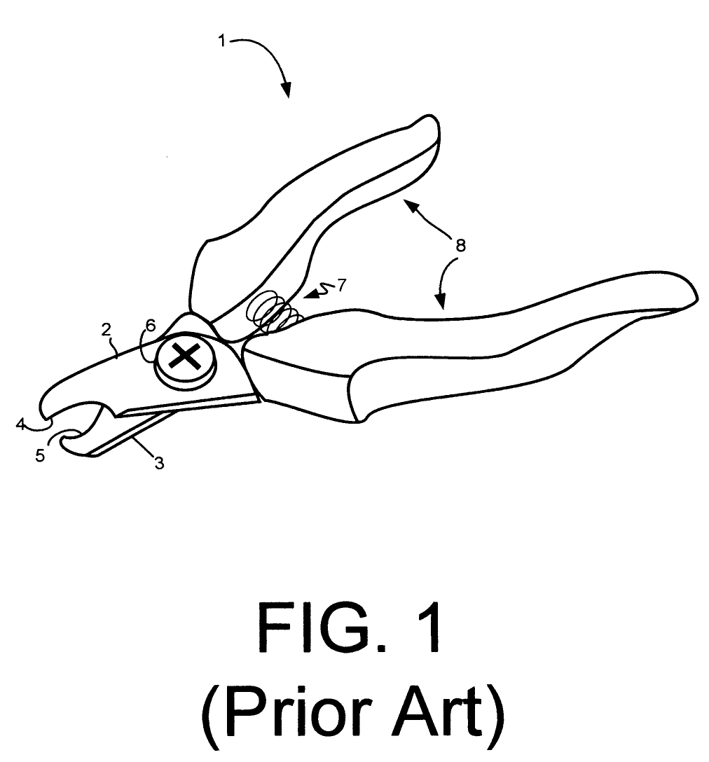

Referring now in more detail to the drawings, in which like numerals indicate corresponding parts throughout the several views, FIG. 1 illustrates a conventional nail clipper 1 used to cut an animal's nails. The nail clipper 1 is generally comprised of a pair of cutting blades 2 and 3, each with a cutting edge 4 and 5, positioned reciprocate of each other. A handle 8 is coupled to the pair of cutting blades 2 and 3. A bolt 6 is used to couple the blades 2 and 3 and to pivot in a first plane. A biasing spring 7 can also be included to bias the handles 8 in an open position. In some cases, the biasing spring 7 may be excluded.

Typically, the cutting blades 2 and 3 are composed of hardened metal, sharpened at the edges 2 and 3. The handle 8 can be composed of a hardened plastic, rubber, metal, or wood.

In practice, the nail clippers 1 function very similar to a pair of scissors. A user places the target nail between the cutting edges 4 and 5, grips the handle 8, and squeezes to cause the cutting edges 4 and 5 to come together and clip the target nail.

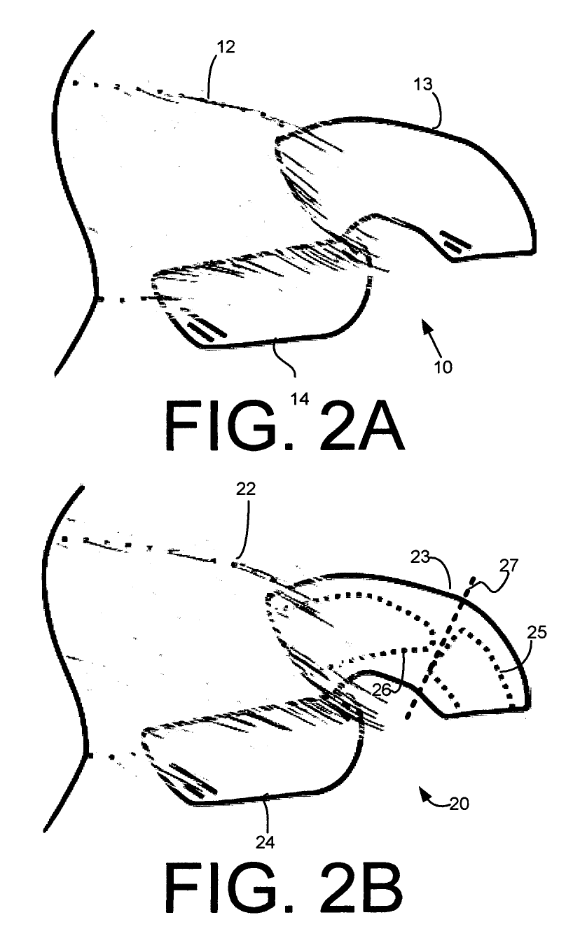

FIG. 2A is an illustration 10 of an animal's nail when not illuminated by a device embodying the present invention. A nail 13 protrudes from a toe 12. Often, the nail 13 will curve as it grows out from the toe 12. A pad 14 is often found on the bottom of the toe 12.

FIG. 2B is an illustration 20 of a pet's nail 23 when transilluminated by a device embodying the present invention. Similar to the nail 13 of FIG. 2A, nail 23 grows from the toe 22, and tends to curve downward as it grows. When transilluminated by a light source, that is when illuminated to reveal the interior of the nail 13, the quick 26 becomes viewable. A target cutting area 27 is beyond the tip of the quick 26.

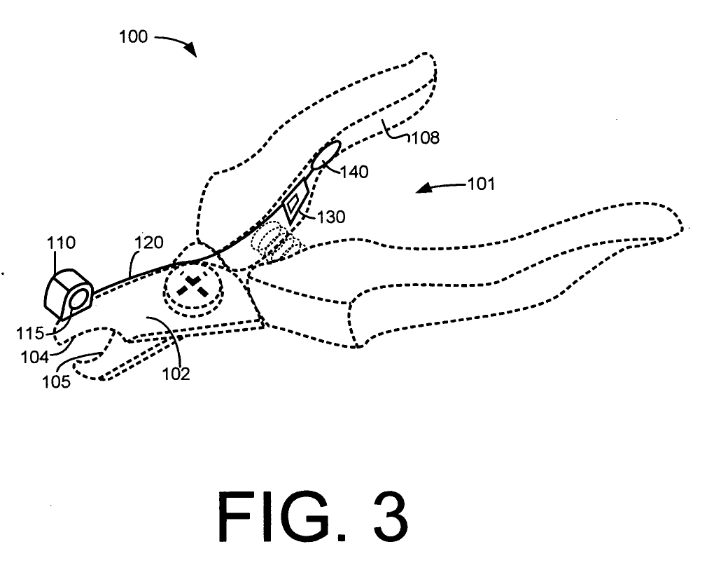

FIG. 3 is a perspective view illustrating an embodiment of an enhanced nail clipper system 100 in accordance with the present invention. Enhanced nail clipper system 100 is illustrated as mounted or affixed to a conventional nail clipper 101. In this case, the system 100 may be an aftermarket product and retrofitted to one of a number of nail clipper models.

The first embodiment of the enhanced nail clipper system 100 includes a lighting element 115 confined within a lighting housing 110. The lighting housing 110, in this embodiment is mounted atop a first blade member 102 and positioned in such a way as to transilluminate a target nail when placed between the cutting edges 104 and 105 of the nail clipper 101.

The lighting element 115 is powered by a wire lead 120 running from the lighting housing 110 to a toggle switch 130. In this case the toggle switch 130 is mounted on an interior portion of the handle 108 of the nail clipper 101. The toggle switch 130 is wired to a power supply 140.

The lighting element 115 could utilize a number of illumination technologies. Light emitting diodes (LEDs), incandescent, and laser are all types of lighting elements that could be used to transilluminate the target nail. It should be construed by those having ordinary skill in the art that any of these lighting technologies mentioned and those not mentioned could be utilized and should be broadly captured as a lighting element 115. All such embodiments should be included within the scope of the present invention without departing from the spirit of the invention.

The particular footprint of the lighting housing 110 is beyond the scope of the present invention. The housing 110 can be mounted or affixed to the cutting blade 102 in a number of ways including by adhesive, such as glue or epoxy, or magnetically. The manner and approach in which the housing 110 is affixed to the cutting blade 102 is generally beyond the scope of the present invention.

There are a number of on/off type switches known in the art that could be used as the aforementioned toggle switch 130. Some examples of switches include: push button on/off switches, dip switches, compression switches, motion-sensitive switches, membrane switches, capacitive switches, and rotary switches. It should be construed by those having ordinary skill in the art that any of these switching technologies mentioned and those not mentioned could be utilized and have been broadly defined as a toggle switch 130. All such embodiments should be included within the scope of the present invention.

Power supply 140 could be any of a number of power supplies, such as a potential energy source (battery) or kinetic energy converter. The particular power generation technology is beyond the scope of the present invention. The power supply 140, although illustrated as being integrated with the handle 108 of the nail clippers 101, could be positioned in a number of ways. For example, the power supply 140 (and switch 130) could be integrated in with the lighting housing 110 to comprise one single element. The particular positioning and the particular type of power supply are beyond the scope of this embodiment of the present invention

In practice, a user turns on the system 100, by toggling the switch 130 to an on position. A target nail is positioned between the cutting edges 104 and 105 of the clippers 101 such that the lighting element 115 transilluminates the matter comprising the target nail. Upon locating the quick, the user can align the cutting edges 104 and 105 accordingly, and make an accurate cut.

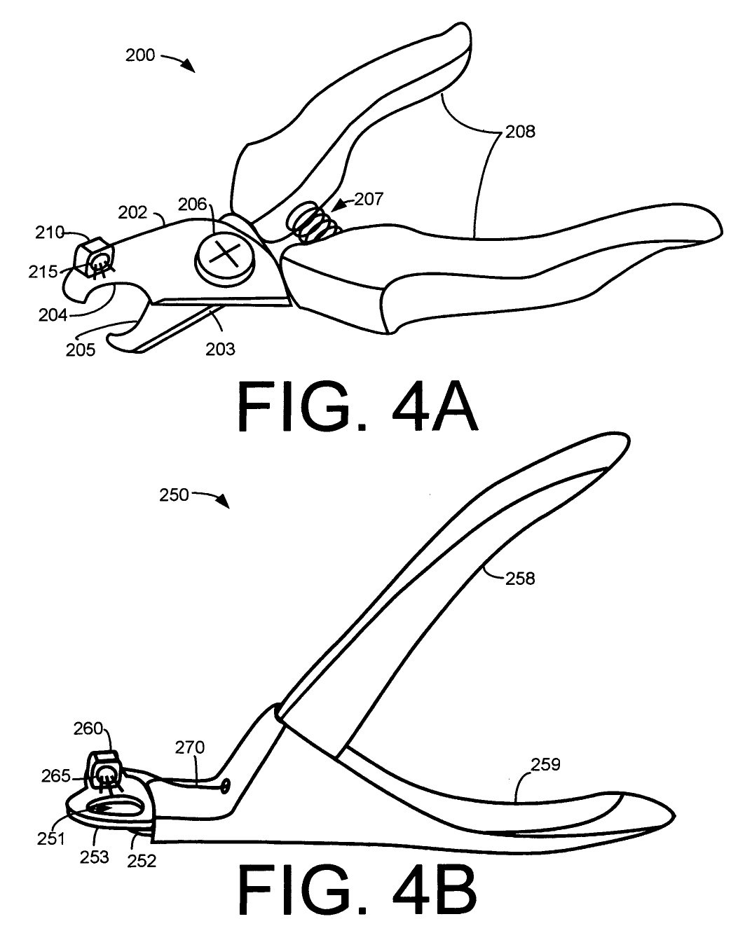

FIG. 4A is a perspective view illustrating a first embodiment of an enhanced nail clipper 200 in accordance with the present invention. In this embodiment, a lighting element 215 and its accompanying housing 210 are integral with the nail clipper 200. In this embodiment, the lighting housing is mounted to a cutting blade 202 of the clipper 200. In alternative embodiments, the lighting element 215 may be housed elsewhere, such as in the handle 208 of the clippers 200, and a fiber optic cable and/or some other lighting conduit, such as a lightpipe, could be used to direct light to the appropriate position relative to the cutting edges 204 and 205. The lighting element 215 could also be placed on the outside edge of the cutting element so that it shines on both sides of the blade 202.

FIG. 4B is a perspective view illustrating a second embodiment of an enhanced nail clipper 250 in accordance with the present invention Nail clipper 250 is based upon a second type of animal nail clipper prevalent in the market today. Nail clipper 250, is comprised of a first handle 258 and a second handle 259 that are movable with respect to each other in a first plane of motion in order to provide relative movement between a first cutting blade 252 and a stationary anvil 253. Cutting blade 252 moves with respect to anvil 253 in a second plane of motion, which in this embodiment, is substantially perpendicular to the first plane of motion.

Stationary anvil 253 is molded such that a hole exists 251. The hole 251 is positioned to receive a target nail, whereby the first cutting blade 252 will sweep across and cut the target nail when the first and second handles 258 and 259 are squeezed together. A biasing spring (not shown) may be positioned between the first and second handles 258 and 259 to bias the clipper 250 in an open position.

Nail clipper 250 further includes a lighting element 265 positioned relative to the hole 251 so as to transilluminate the medium of the target nail. Lighting element 265 is placed within a lighting housing 260 which is affixed and/or integrated with the stationary anvil 253. A wire 270 is illustrated in this embodiment, which is used to deliver power to the lighting element 265 from a power source (not shown).

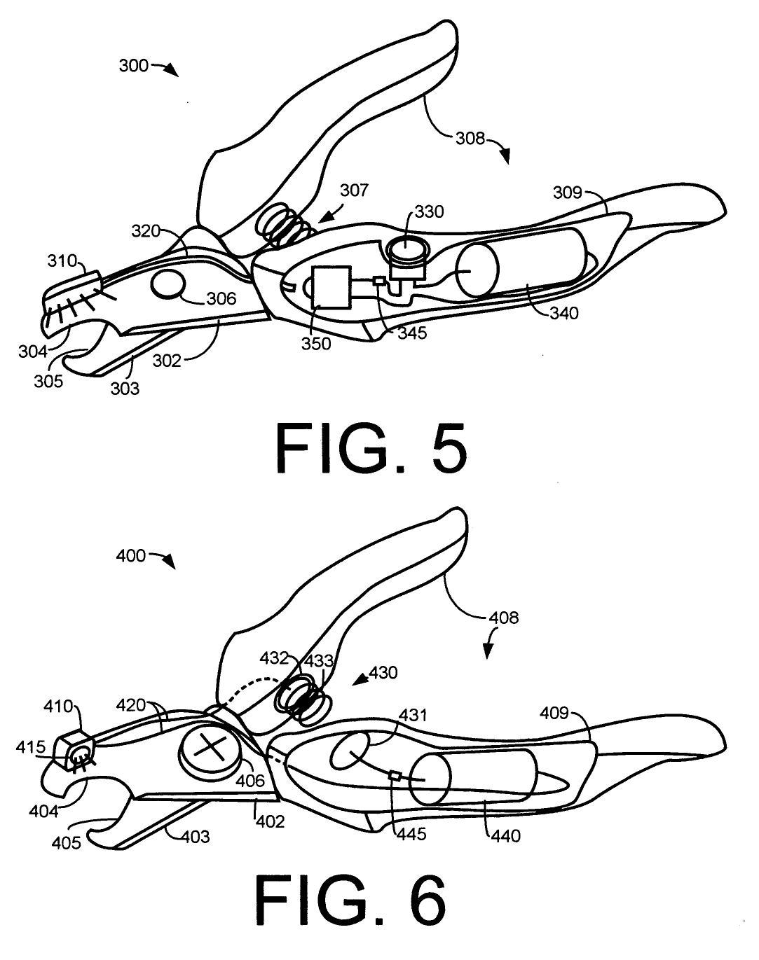

FIG. 5 is a perspective view illustrating a third embodiment of the enhanced nail clipper 300 in accordance with the present invention. Again, a conventional nail clipper is the basis of the enhanced nail clipper 300. Nail clipper 300 includes handles 308 coupled with opposing cutting blades 302 and 303, each with cutting edges 304 and 305. When the handles are squeezed together, the cutting edges, 304 and 305, close against each other in a first plane, thus cutting a target nail. A biasing spring 307 can be used to bias the handles 308 in an open position.

Enhanced nail clipper 300 includes a lightpipe 310 positioned to transilluminate a target nail to be positioned by the user between the cutting edges 304 and 305. A fiber optic cable 320, or some other means, is used to direct light from a lighting element 350 to the lightpipe 310. The lighting element 350, in this embodiment, is embedded in a cavity 309 of one of the handles 308.

Coupled to the lighting element 350 is a push-button switch 330. A power source 340 is also housed within the cavity 309. Certain electronic components 345, such as diodes or resistors can also be found in the cavity. The push-button switch 330 can protrude from the handle 308, such that the user can turn on and off the lighting element 350 when desired. Again a number of switching technologies could be used without departing from the spirit of the present invention.

FIG. 6 is a perspective view illustrating a fourth embodiment of the enhanced nail clipper 400 in accordance with the present invention. Enhanced nail clipper 400 is similar to that of FIG. 4A, wherein a lighting element 415 is positioned relative to the cutting edges 404 and 405 to transilluminate a target nail. Lighting housing 410 is mounted or integrated with a cutting blade 402. A cavity 409 in one of the handles 408 houses a power source 440 and possibly some discrete electronic components 445. Enhanced nail clipper 400 further includes a compression switch 430 to control power being delivered to the lighting element 415.

The compression switch 430 is comprised of first and second contact points 431 and 432, mounted reciprocal each other on an interior portion of the handle 408. A spring 433 is coupled to one of the contact points. When the handles are squeezed together, the spring 433 comes into contact with both contact points, thus completing a circuit and delivering power to the lighting element 415. Not shown is a biasing spring which may be mounted between the handles 408 and exclusive of the compression switch 430.

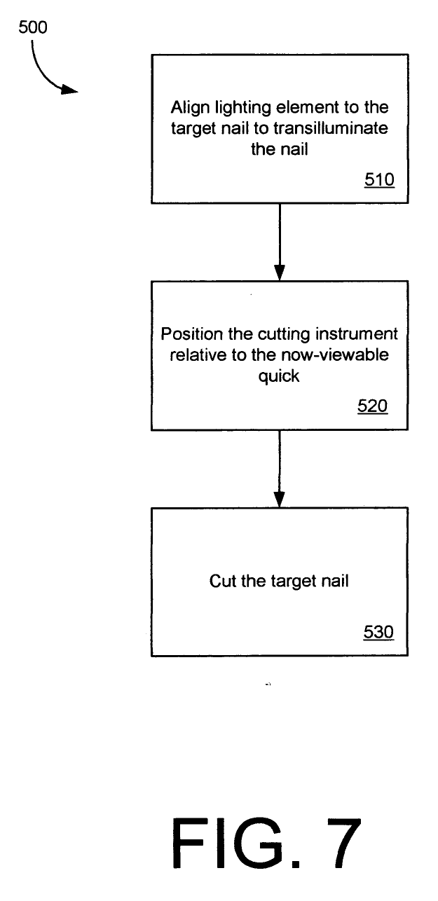

FIG. 7 is a block diagram illustrating a novel method 500 for grooming an animal's nails in accordance with the present invention. The method 500 begins by aligning a lighting element with a target nail so as to transilluminate the nail, thus exposing the quick (step 510). This can be accomplished in a number of ways, such as those illustrated in previous figures. Other conceived methods of accomplishing this step are by placing a light source, not part of the nail clipper, in a position such that the target nail is transilluminated. Such a light could be a desk lamp or a light source integrated with the procedure table.

The method 500 continues by positioning the cutting instrument along the target nail so as to cut off the desired length while not cutting the quick (step 520). The quick is now viewable by way of step 510. The method 530 proceeds with cutting the target nail 530.

It should be emphasized that the above-described embodiments of the present invention, are merely possible examples of implementations, merely set forth for a clear understanding of the principles of the invention. Many variations and modifications may be made to the above-described embodiment(s) of the invention without departing substantially from the spirit and principles of the invention. All such modifications and variations are intended to be included herein within the scope of the present invention and protected by the following claims.

1. A system for enhancing the clipping of a nail, said system comprising:
a lighting element for transilluminating the nail;
a power supply for powering said lighting element; and
a switch for activating said lighting element.

2. The system of claim 1, wherein said switch is an on/off toggle switch.

3. The system of claim 1, wherein said switch is a compression switch.

4. The system of claim 1, wherein said lighting element is at least a first light emitting diode (LED).

5. The system of claim 1, further comprising a lightpipe for directing light, generated by said lighting element, to a target location.

6. The system of claim 1, further comprising:
a magnet for magnetically coupling said lighting element to a nail clipper blade.

7. The system of claim 1, wherein said lighting element transilluminates the nail such that the quick of the nail becomes visible.

8. The system of claim 1, wherein said power supply is a kinetic energy converter.

9. A nail clipper, comprising:
a lighting element coupled to a first blade member, wherein said lighting element is positioned to transilluminate a patient's nail.

10. The nail clipper of claim 9, further comprising:
a switch for activating said lighting element.

11. The nail clipper of claim 10, wherein said switch is a toggle switch integrated into a handle of said nail clipper.

12. The nail clipper of claim 10, wherein said switch is a compression switch integrated between first and second reciprocating handles of said nail clipper.

13. The nail clipper of claim 9, further comprising:
a power supply.

14. The nail clipper of claim 9, wherein said lighting element is at least a first LED.

15. A system for enhancing the clipping of a patient's nail, said system comprising:
means for transilluminating the patient's nail such that the quick of the nail becomes better visible.

16. The system of claim 15, further comprising:
means for activating said means for transilluminating.

17. The system of claim 15, wherein said means for transillumating comprises:
means for generating light;
means for directing light generated from said means for generating light to a particular location relative to a patient's nail, such that the patient's nail is transilluminated.

18. A method for better manicuring an animal's nail, said method comprising:
aligning a lighting element to a target nail such that the target nail is transilluminated to visually expose the location of the animal's quick;
positioning a cutting instrument to a desirable location, relative to the quick, of the target nail; and
cutting the target nail with the cutting instrument.
